(19) United States
(12) Patent Application Publication
(10) Pub. No.: US 2012/0034484 A1
(43) Pub. Date: Feb. 9, 2012

(54) METAL FOIL

(75) Inventor: Rainer Behrens, Iserlohn (DE)

(73) Assignee: THYSSENKRUPP VDM GMBH, Werdohl (DE)

(21) Appl. No.: 13/264,085

(22) PCT Filed: Apr. 29, 2010
(86) PCT No.: PCT/DE10/00490

§ 371 Date: Oct. 12, 2011

(30) Foreign Application Priority Data
May 20, 2009 (DE) 10 2009 022 203.0

(51) Int. Cl. B21C 1/00; B21B 27/06; B21D 31/00

(52) U.S. Cl. 428/577; 72/364; 72/200

(57) ABSTRACT

Metal foil for the catalytic production of hydrogen, having the following chemical composition (in % by weight): C 0.001 to 0.5%; S max. 0.008%; N 0.1 to 0.3%; Cr 24 to 28%; Ni 30 to 33%; Mn 1.0 to 2.0%; Si 0.005 to 0.2%; Mo 6.0 to 7.5%; Ti max. 0.05%; Nb max. 0.05%; Cu 0.8 to 2.0%; P max. 0.025%; AI max. 0.2%; Cer composition metal 0.01 to 0.1%; W max. 0.5%; Co max. 0.5%; B 0.001 to 0.05%; the remainder being Fe and production-related impurities.

The invention relates to a metal foil for the catalytic production of hydrogen.

It is generally known to produce hydrogen and oxygen by means of the combination of a solar cell, in which an electric current is produced, and an electrolyte cell, in which water is broken down, by means of this electric current, into hydrogen and oxygen, which can then be stored and converted into electrical energy again, in a fuel cell, if necessary. This mixture of hydrogen and oxygen—the so-called detonating gas—is highly explosive. Handling of this mixture sets great requirements in terms of safety technology. Furthermore, the technical effort is sizable.

DE 35 35 395 relates to the production of hydrogen gas, whereby a fine-particle metallic catalyst is contacted with water that contains a chelate-forming agent, at a temperature between 60 and 150° C. The fine-particle metallic catalyst is selected from the group of nickel, cobalt, iron, palladium, platinum, copper, magnesium, manganese. Preferably, the metallic catalyst should mainly consist of nickel or alloys of nickel.

It is the goal of the object of the invention to make available a metal foil for the catalytic production of hydrogen, from an alloy that can be predetermined.

Furthermore, a method for the production of such a metal foil is supposed to be proposed.

Finally, the metal foil itself is supposed to be suitable for special application cases.

This goal is achieved by means of a metal foil for the catalytic production of hydrogen, having the following chemical composition (in wt.-%):
C 0.001 to 0.5%
S max. 0.008%
N 0.1 to 0.3%
Cr 24 to 28%
Ni 30 to 33%
Mn 1.0 to 2.0%
Si 0.005 to 0.2%
Mo 6.0 to 7.5%
Ti max. 0.05%
Nb max. 0.05%
C 0.8 to 2.0%
P max. 0.025%
Al max. 0.2%
Cerium MM 0.01 to 0.1%
W max. 0.5%
Co max. 0.5%
B 0.001 to 0.05%
Fe remainder
   and contaminants resulting from production.

Advantageous further developments of the metal foil according to the invention can be derived from the related dependent claims.

This goal is also achieved by means of a method for the production of a metal foil made from the chemical compositions described above, which foil is brought to a final thickness <1.0 mm by means of mechanical cold forming and/or hot forming of a semi-finished product, if necessary with at least one heat/annealing treatment.

According to another idea of the invention, the mechanical shaping is carried out by means of rolling, if necessary with single or multiple annealing. Hard metal rollers are used, particularly towards the end of the rolling process, which rollers are advantageously provided with a maximal roughness of 0.5 μm.

It is furthermore advantageous if the foils are degreased with an electrolyte stripper before the annealing process, in each instance.

It is particularly advantageous to use rolling oil having a specific chemical composition during the course of the rolling process to a final thickness <1.0 mm, whereby then, a rolling oil film having a film thickness that can be predetermined remains on the foil surface at the end of the final roiling process.

This foil-like semi-finished product, prepared in this way, is now subjected to a special thermal treatment, which will be described below, to produce an oxide layer, having a layer thickness that can be predetermined, on the foil surface. By means of this measure, defined spinel structures can be generated on the foil surface.

Subsequent to the mechanical shaping, the metal foil is thermally treated for a time of 5 to 60 minutes, at a temperature of 500 to 1000° C., under an atmosphere that contains oxygen.

It is particularly advantageous if the metal foil is thermally treated in a muffle furnace, during a time of 5 to 40 minutes, at a temperature of 550 to 950° C., under an atmosphere that contains oxygen.

Such metal foils can preferably be used as solid metal catalysts for the production of hydrogen from an aqueous solution, in interaction with a light source.

In this connection, sunlight is supposed to be used as an effective and inexpensive light source.

Water is the most widespread solvent that is known as an aqueous solution. Here, not only drinking water but also salt water is meant.

Furthermore, however, acids and bases can also be considered to be aqueous solutions, and can be used for the production of hydrogen.

The metal foils are advantageously mechanically formed at final ceilings between 0.01 to 1.0 mm, whereby the heat treatment and/or annealing treatment that has been mentioned can be carried out.

In the following table, two alloy compositions according to the invention are reproduced.

| Alloy | Alloy 1 | Alloy 2 |
|---|---|---|
| element | (wt.-%) | (wt.-%) |
| C | 0.01% | 0.075% |
| N | 0.16% | 0.22% |
| Cr | 26.80% | 27.10% |
| Ni | 31.20% | 31.50% |
| Mn | 1.48% | 1.50% |
| Si | 0.08% | 0.09% |
| Mo | 6.5% | 6.6% |
| Cu | 1.23% | 1.18% |
| Cerium MM | 0.04% | 0.05% |
| B | 0.003% | 0.005% |
| Fe | remainder | remainder |

The other elements indicated in the claims are either only present in trace form, or are considered to be contaminants resulting from production.

For an experiment, metal foils having a thickness of 0.02 mm, produced according to the cold forming and/or hot forming method according to the invention, particularly by means of rolling, of the above alloys were used. The metal foils were subjected to thermal treatment in a muffle furnace for 8 minutes, at 800° C., under an atmosphere that contains oxygen. By means of this measure, it was possible to produce an oxide layer having a defined oxide thickness on the foil surface, which layer then makes it possible to use the foil in interaction with an aqueous solution, as well as a light source, for the production of hydrogen.

4 cm² or 0.282 g, respectively, of these metal foils that can be used as a catalyst, were subsequently inserted into a 100 ml beaker. 65 g of drinking water were added to this, as a solvent, and the beaker, containing the solid metal catalyst, was exposed to sunlight. Visible formation of gas bubbles started on the catalyst foil.

1. Metal foil for the catalytic production of hydrogen, having the following chemical composition (in wt.-%):
C 0.001 to 0.5%
S max. 0.008%
N 0.1 to 0.3%
Cr 24 to 28%
Ni 30 to 33%
Mn 1.0 to 2.0%
Si 0.005 to 0.2%
Mo 6.0 to 7.5%
Ti max. 0.05%
Nb max. 0.05%
Cu 0.8 to 2.0%
P max. 0.025%
Al max. 0.2%
Cerium MM 0.01 to 0.1%
W max. 0.5%
Co max. 0.5%
B 0.001 to 0.05%
Fe remainder
and contaminants resulting from production.

2. Metal foil according to claim 1, having the following composition (in wt.-%):
C 0.001 to 0.02%
S max. 0.005%
N 0.15 to 0.25%
Cr 26 to 27.5%
Ni 31 to 32%
Mn 1.2 to <2.0%
Si 0.01 to <0.1%
Mo 6.0 to 7.0%
Ti max. 0.05%
Nb max. 0.05%
Cu 1.0 to <2.0%
max. 0.02%
Al max. 0.15%
Cerium MM 0.02 to <0.1%
W max. 0.3%
Co max. 0.5%
B 0.001 to 0.01%
Fe remainder
and contaminants resulting from production.

3. Method for the production of a metal foil according to claim 1, which is brought to a final thickness <1.0 mm by means of mechanical cold forming and/or hot forming of a semi-finished product, if necessary with at least one heat/annealing treatment.

4. Method according to claim 3, wherein rollers, particularly hard metal rollers, are used for the mechanical shaping to produce foils <1.0 mm.

5. Method according to claim 3, wherein hard metal rollers having a roughness Ra <0.5 μm are used for rolling foils to final thicknesses <1.0 mm.

6. Method according to claim 3, wherein the foils are degreased with an electrolyte stripper before an annealing process.

7. Method according to claim 3, wherein rolling oil is used during the course of the rolling process to a final thickness <1.0 mm, whereby then, a rolling oil film having a film thickness that can be predetermined remains on the foil surface at the end of rolling.

8. Method according to claim 3, wherein the foil is thermally treated, subsequent to the mechanical shaping, for a time of 5 to 60 minutes, at a temperature of 500 to 1000° C., under an atmosphere that contains oxygen.

9. Method according to claim 3, wherein the metal foil is thermally treated in a muffle furnace, during a time of 5 to 40 minutes, at a temperature of 550 to 950° C., under an atmosphere that contains oxygen.

10. Method according to claim 3, wherein an oxide layer having a defined layer thickness can be adjusted on the foil surface, as a function of the foil thickness and the type of thermal treatment.

11. Use of a metal foil according to claim 1 as a solid metal catalyst for the production of hydrogen from an aqueous solution, in interaction with a light source.

12. Use of a metal foil according to claim 1 as a solid metal catalyst for the production of hydrogen from an aqueous solution, in interaction with sunlight.
